(19) United States
(12) Patent Application Publication
(10) Pub. No.: US 2008/0298058 A1
(43) Pub. Date: Dec. 4, 2008

(54) Cove Illumination Module and System

(75) Inventors: Peter Kan, North Vancouver (CA); Adrian Weston, New Westminister (CA); George Matheson, North Vancouver (CA); Damon Campbell, Anchorage, AK (US); Lawrence Schmeikal, Coquitlam (CA); Stephen Flood, New Westminister (CA)

Correspondence Address: PHILIPS INTELLECTUAL PROPERTY & STANDARDS, 3 BURLINGTON WOODS DRIVE, BURLINGTON, MA, 01803, US

(73) Assignee: TIR SYSTEMS LTD., Burnaby, (CA)

(21) Appl. No.: 10/588,019

(22) PCT Filed: Apr. 28, 2006
(86) PCT No.: PCT/CA2006/000670

§ 371 Date: Aug. 19, 2008

Related U.S. Application Data
(60) Provisional application No. 60/683,234, filed on May 20, 2005.
(60) Provisional application No. 60/715,941, filed on Sep. 9, 2005.

(51) Int. Cl. F21S 15/00

(52) U.S. Cl. 362/240

(57) ABSTRACT

The present invention provides a cove illumination module for use in a plurality of illumination applications wherein a particular type of cove type illumination pattern is desired due to close proximity between the cove illumination module and a to-be-illuminated surface. The cove illumination module comprises a substrate to which a plurality of light-emitting elements is operatively connected. Optionally, the substrate can form a base portion of the cove illumination module. An external housing unit is sealingly mated with the substrate in order to environmentally seal the light-emitting elements. The external housing unit comprises one or more optical elements which can shape the beams of light emitted by the light-emitting elements under operating conditions and generate a desired illumination pattern on a lit surface, thereby providing a cove type illumination pattern.

### FIELD OF THE INVENTION

The present invention pertains to the field of lighting and in particular to a cove illumination module and system.

### BACKGROUND

Recent advances in the development of semiconductor and organic light-emitting diodes (LEDs and OLEDs) have made these solid-state devices suitable for use in general illumination applications, including architectural, entertainment, and roadway lighting, for example. As such, these devices are becoming increasingly competitive with light sources such as incandescent, fluorescent, and high-intensity discharge lamps.

Having particular regard to canopies in the sign industry, many of these canopies need to be illuminated to draw attention and attract potential customers. Some translucent or transparent canopies can effectively transmit light of various colors and can be backlit if desired. Others typically use an ACM (aluminium composite material) surface which is coloured and in order to illuminate this surface there is required a light source mounted below or above this surface to illuminate the coloured surface. For this application, a cove lighting system is normally provided to conceal the illumination product while providing the desired illumination. As is known uniform illumination of the canopy is desired, without the appearance of illumination hotspots. A cove lighting system, however, is typically not very deep resulting in a tight setback distance between the light source and the surface to be illuminated thereby typically resulting in the appearance of undesired illumination hot spots.

U.S. Pat. No. 6,700,502 discloses a strip LED light assembly for use as a warning signal light for motor vehicles. The assembly has a number of LEDs on a board or LED mounting surface, a reflector or culminator, and a cover enclosing the LEDs. The warning signal light provides various coloured light signals for independent use or use by an emergency vehicle. A cover is provided to enclose the LED light assembly, however environmental protection of the LED light assembly may not be provided due to mounting apertures being configured within both the cover and the mounting surface.

U.S. Pat. No. 6,939,029 discloses a modular light for decorative use on light strips on motorcycles or similar vehicles. It has an outer lens or light transmitting housing that forms an interior chamber. The chamber has an open side, and a light-transmitting wall opposite from the open side. A circuit board with LEDs is shaped to close the open side of the chamber in the light-transmitting housing. The circuit board supports a reflector that has openings through which the LEDs protrude. The circuit board is secured in place in the light-transmitting housing to form a modular light. The modular light fits into a support housing on a light support strip or similar structure to mount the modular light in place. The optics provided for the manipulation of the light generated by the LEDs are positioned on the circuit board.

U.S. Pat. Nos. 6,673,293, 6,673,292 and 6,113,248 describe an integral single piece extruded light-emitting diode (LED) light strip and a method for its manufacture. The light strip includes spaced apart first and second bus elements. The light strip also includes at least one LED connected between the bus elements to generate light when the first bus element conducts electricity. An extruded plastic material completely encapsulates the first and second bus elements and the LED, thereby providing a barrier to protect the elements from damage and to make the light strip resistant to moisture. A process for manufacturing an integrally formed single piece light strip includes the steps of continuously feeding bus elements to an extruder; continuously feeding circuitry having at least one LED operatively mounted thereon to the extruder; and extruding a thermoplastic material at a temperature below that which would damage the circuitry or the LED to thereby encapsulate the bus elements, the circuitry and the LED and to operatively connect the circuitry to the bus elements. The design of this light strip requires that the LEDs be surrounded and encapsulated by an integrally formed and extruded housing.

U.S. Pat. No. 6,997,575 describes a border lighting strip and a method for its manufacture. The strip includes an electrical cable with electrical conductors and light emitting devices (LEDs) electrically connected along the electrical cable. A hollow extruded sheath of translucent or transparent material receives the LEDs and includes an integrally formed cylindrical optical lens. The method for manufacture includes electrically connecting LEDs to an electrical cable to form a linear light source, extruding a transparent or translucent sheath adapted to receive the linear light source, and inserting the linear light source into the extruded sheath to form the border lighting strip. The design of this lighting strip requires that the LEDs be surrounded and encapsulated by an integrally formed and extruded sheath.

U.S. Pat. No. 6,965,205 describes implementations of light-emitting diode-based illumination devices and methods including glow sticks, key chains, toys, balls, light bulbs, lights and wall switches among others. These devices may be equipped with various types of user interfaces (both “local” and “remote”) to control light generated from the device. The products can also include optical processing devices, for example reflectors or diffusers. The design of these illumination devices requires the LEDs be surrounded and encapsulated by an integrally formed housing.

U.S. Pat. No. 6,851,832 describes LED tube light housings configured to control and orient the lateral position of inserted LEDs on a wiring harness. An LED tube light housing includes a first end, a second end, an inner surface, and an outer surface. First and second sections are generally formed inside the housing. The first section is configured in the form of a cavity for providing a vertical orientation of one or more LEDs. At least the top of the first section, e.g., the cavity, is transparent, translucent, or the like, to permit the transmission of light emitted by the LEDs. The remaining portion of the housing may be transparent, translucent, opaque, or a combination thereof. The second section is configured to contain electrical components of the wiring harness. No printed circuit board portions are included in the wiring harness. The LEDs are surrounded and encapsulated by an integrally formed housing.

U.S. Pat. No. 6,796,680 describes a strip lighting device which includes an elongate housing, a plurality of light sources arranged at intervals within the housing, and a fastener for fastening the elongate housing to a surface. The elongate housing overlies the plurality of light sources and diffuses, disperses or scatters light from the light sources such that individuals of the plurality of light sources are substantially not distinguishable when the housing is viewed from the outside. The design of this strip lighting device requires that the LEDs be surrounded and encapsulated by an integrally formed housing.

U.S. Pat. No. 7,014,336 describes systems for generating and/or modulating high-quality illumination conditions which meet a desired and controllable color. These systems can be used to implement lighting fixtures for producing light in desirable and reproducible colors and for modifying the color temperature or color shade of light. LED lighting units capable of generating light of a range of colors are used to provide light or supplement ambient light to provide desired lighting conditions. This design requires the LEDs be surrounded by a multi-section encapsulating housing.

U.S. Pat. No. 5,785,414 describes a lighting system which comprises a housing which contains a light emitting diode that fits into a lens. The lens is secured to the housing so that the position of the lens relative to the housing is also fixed. One or more housings are fitted into a channel which is closed by a transparent or translucent cover. This design requires the LEDs be surrounded by a multi-section encapsulating housing.

United States Patent Publication No. 2005/0180133 describes a lighting fixture which provides a substantially uniform line of light for illumination or signage. It uses a linear array of LEDs. The LEDs are arranged within a reflective shell within the fixture and one or more elongated cylindrical focusing lenses are positioned at a specific distance in front of the LEDs to focus the light into a line of light. The design configuration of this lighting fixture is to generate a line of light and not to illuminate a sign face.

Therefore there is a need for a new cove illumination module and system that can achieve the desired optical distribution of the light from the light source over a canopy or similar feature enabling substantially uniform illumination thereof to be achieved.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a cove illumination module and system. In accordance with an aspect of the present invention, there is provided a cove illumination module for illuminating a cove, the module comprising: a substrate having one or more light-emitting elements operatively mounted thereon, said one or more light-emitting elements generating light having one or more wavelengths; and an external housing unit sealingly connected to the substrate, said external housing element including one or more optical elements optically coupled to the one or more light-emitting elements, said one or more optical elements manipulating the light in a desired manner thereby illuminating the cove; wherein the substrate is adapted for connection to a source of power thereby enabling activation of the one or more light-emitting elements

### BRIEF DESCRIPTION OF THE FIGURES

FIG. 1 shows a cove illumination module according to one embodiment of the present invention.

FIG. 2 shows a lighting system according to one embodiment of the present invention, the lighting system comprising two or more cove illumination modules and a support structure prior to interconnection of the cove illumination modules and the support structure.

FIG. 3 shows an exploded view of a cove illumination module according to an embodiment of the present invention.

FIG. 4 shows an assembled view of the cove illumination module illustrated in FIG. 3.

FIG. 5 shows a cove illumination module according to another embodiment of the present invention.

FIG. 6 shows a cove illumination module according to another embodiment of the present invention.

FIG. 7 shows a cove illumination module according to another embodiment of the present invention.

FIG. 8A shows a snap clip mated with a housing of a cove illumination module according to one embodiment of the present invention.

FIG. 8B is an exploded view of FIG. 8A illustrating the snap clip and housing of the cove illumination module separately.

FIG. 9A shows a lock bracket for positioning of a cove illumination module according to one embodiment of the present invention.

FIG. 9B shows a spring clip for positioning of a cove illumination module according to one embodiment of the present invention.

FIG. 10 shows an illustration of a cove illumination module according to an embodiment of the present invention.

FIG. 11 shows an illustration of components of the cove illumination module as illustrated in FIG. 10.

FIG. 12 shows an illustration of an assembled cove illumination module which comprises a plurality of light-emitting elements according to one embodiment of the present invention.

FIG. 13 shows the insert comprising the light-emitting elements and the optics for the cove illumination module of FIG. 12.

FIG. 14A illustrates a perspective view of a substrate with vias and a light-emitting element according to one embodiment of the present invention.

FIG. 14B illustrates a cross sectional view of a substrate with vias and a light-emitting element of FIG. 14A.

FIG. 15 illustrates a substrate with light-emitting elements and optical elements mounted thereon which can be inserted into the housing of a cove illumination module according to one embodiment of the present invention.

FIG. 16 illustrates a cut out view of a cove illumination module according to one embodiment of the present invention.

FIG. 17 illustrates a cross section of an optical element of a cove illumination module according to one embodiment of the present invention.

FIG. 18 shows a schematic of a light-emitting element drive current control circuit according to one embodiment of the present invention.

FIG. 19 shows a schematic of a light-emitting element drive current control circuit according to another embodiment of the present invention.

### DETAILED DESCRIPTION OF THE INVENTION

### Definitions

The term “light-emitting element” is used to define any device that emits radiation in any region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or any other similar light-emitting devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides a cove illumination module for use in a plurality of illumination applications wherein a particular type of cove type illumination pattern is desired due to close proximity between the cove illumination module and a to-be-illuminated surface. The cove illumination module comprises a substrate to which a plurality of light-emitting elements is operatively connected. Optionally, the substrate can form a base portion of the cove illumination module. An external housing unit is sealingly mated with the substrate in order to environmentally seal the light-emitting elements and related electronics. The external housing unit comprises one or more optical elements which can shape the beams of light emitted by the light-emitting elements under operating conditions and generate a desired illumination pattern on a lit surface, thereby providing a cove type illumination pattern. Optionally, the external housing unit can comprise fastening means for the interconnection of the housing unit to a mounting rail, track or mounting site, for example in order to provide a means for ease of placement and orientation of the cove illumination module. The substrate is additionally adapted for connection to a source of power to provide for the activation of the light-emitting elements.

In one embodiment, for the interconnection of adjacent cove illumination modules an environmentally sealable electrical connection can be mounted on the substrate wherein this electrical connection is accessible external to the region enclosed by the external housing unit.

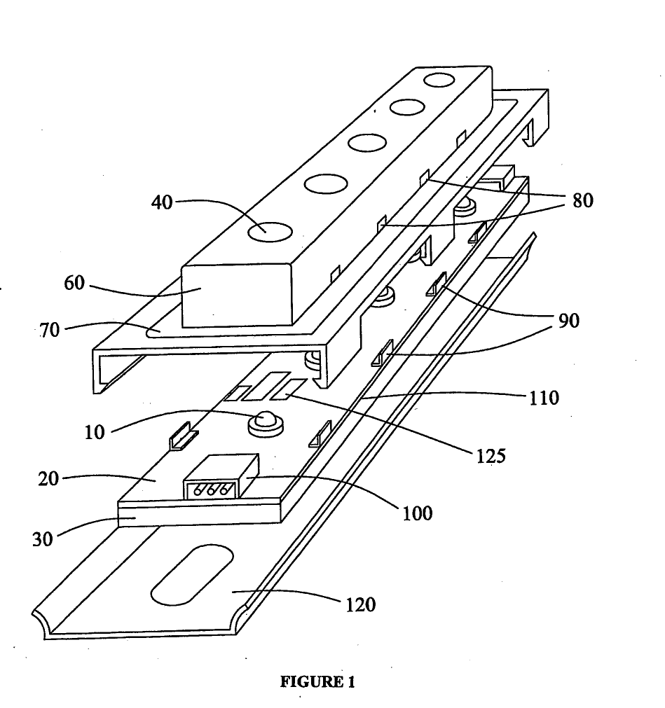

FIG. 1 illustrates a cove illumination module according to one embodiment of the present invention, wherein the light-emitting elements 10 are mounted in a linear array configuration onto the substrate 20 which is in the form of a printed circuit board. Also mounted onto the substrate is electronic drive circuitry 125, for example a pulse width modulation control circuit, which can control the operation of light-emitting elements. One or more optical elements 40, for example a lens, is moulded into the external housing unit 60, wherein the external housing unit can be made of an optically clear or translucent plastic or other material as would be readily understood by those skilled in the art. In order to protect the light-emitting elements and the other electrical devices and circuitry on the substrate from environmental conditions, for example moisture, a gasket material 70 can be disposed on the underside of the external housing unit 60 abutting and sealingly mating with the substrate.

In one embodiment, in order to improve the ease of assembly of the cove illumination module, snap fit features 80 can be moulded with the external housing unit 60 that mate with connecting mechanical clips 90 which are mounted onto the printed circuit board.

In one embodiment, for ease of installation, electrical connectors 100 can be operatively mounted onto the substrate so that they can be accessed from the outside of the external housing unit 60. These connectors 100 can additionally provide a hermetic seal against certain environmental conditions, for example, to prevent penetration of water up to a predefined ambient overpressure.

Optionally, a mechanical feature 110 can be moulded into the external housing unit to secure the cove illumination module onto a standard mounting rail for example a DIN™ 120 or Unistrut™ or other mounting system.

In an alternate embodiment, the external housing unit can comprise bores enabling the passage of fastening means, for example screws, bolts or rivets, which may also provide a means for securing the cove illumination module in a desired location, while maintaining the environmental seal formed between the external housing unit and the substrate.

In one embodiment, a metal core backing 30, for example made of aluminium, is matingly coupled to the substrate which can provide heat dissipation, wherein the metal core backing can be configured to function as a heat sink. Optionally, the substrate can be a metal core printed circuit board (MCPCB) which can enhance heat dissipation.

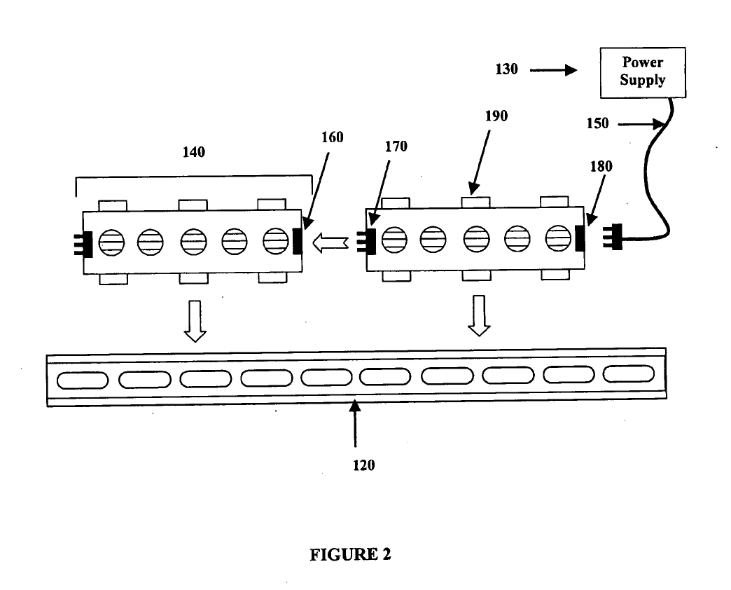

FIG. 2 illustrates a cove illumination system which comprises two cove illumination modules 140. Each cove illumination module 140 can be operatively coupled to another through a uniform connector system, for example mating connectors 160 and 170. Alternatively, connectors 160 and 170 may be indirectly linked by a cable system with appropriate connectors to provide a means for increasing the spacing between the cove illumination modules, if desired. The cove illumination modules can be mounted, for example, onto a support rail 120 which can have appropriately configured mounting features 190. The cove illumination modules can be coupled to a power supply 130 through a connector cable 150 which can be coupled to connector 180. Connector 180 can be compatible with the uniform connector system to fit with either connector 160 or 170. The power supply module 130 can be remote and can supply electrical power to the cove illumination modules 140. In one embodiment, the cable system 150 comprises three poles for coupling the cove illumination modules and the power supply wherein one pole is for ground, one pole is for negative voltage and one pole is for positive voltage.

As would be readily understood, a cove illumination system may comprise one or more power supplies in which each power supply can be used to energise a predetermined number of cove illumination modules. The interconnection of respective cove illumination modules can be determined based on the desired configuration of the cove illumination system.

### Substrate and Lighting Components

One or more light-emitting elements are operatively mounted onto the substrate. The one or more light-emitting elements are electrically and operatively interconnected to a power source which can provides a power for their activation. The substrate is in the form of a printed circuit board wherein the electrical interconnection and the controllers associated with the one or more light-emitting elements are integrated thereon. The substrate can also be utilized to provide an environmental seal in certain cove illumination module designs.

In one embodiment the substrate is a metal core printed circuit board (MCPCB) to provide heat dissipation from the one or more light-emitting elements and/or heat spreading, which can improve light-emitting element thermal operating conditions. In an alternate embodiment of the present invention the substrate is a FR4 board or other board type as would be known to a worker skilled in the art.

In one embodiment of the present invention the substrate can be thermally connected to a heat sink to dissipate the heat generated during operation of the light-emitting elements and the other electronic devices.

The plurality of light-emitting elements can be disposed on the substrate in any regular or irregular arrangement, for example, in a linear format or a planar two dimensional array. A two dimensional array of light-emitting elements can provide higher light-emitting element densities on the substrate which can enable higher luminous flux output from a cove illumination module. In addition, the cove illumination module can comprise light-emitting elements having only certain predefined characteristics. For example, light-emitting elements can emit light of a certain spectrum to generate, through the interaction with the optical elements of the cove illumination module, a desired lighting impression.

In one embodiment the design of the light-emitting elements can be such that the desired illumination colour is a combination of the wavelengths produced by multiple light-emitting elements and the interaction of this light with the type and/or colour of the material used to form the external housing unit.

In one embodiment, the cove illumination module can have light-emitting elements of non-uniform optical characteristics thereby being able to create a desired non-uniform illumination impression. For example, the light-emitting elements in a cove illumination module can have differing chromaticities or luminous flux outputs.

In one embodiment, wherein the light-emitting elements are arranged in a two dimensional array, there can be a desired arrangement of colours of light-emitting elements in a direction perpendicular to the longitudinal axis of the substrate. For example, perpendicular to the longitudinal axis of the substrate light-emitting elements which can produce red, green and blue light are arranged. In this configuration using specific control parameters for each of these three colours of light-emitting elements can enable the generation of substantially any visible colour. In this manner the cove illumination module can generate light of any chromaticity within the gamut defined by the light-emitting elements which are used in the cove illumination module by controlling the amount of light emitted by each colour of light-emitting element during operation.

Further electronics such as control circuits can be integrated onto the substrate to provide a means for controlling the activation and the operational conditions, for example the luminous flux output, of the light-emitting elements. If a uniform luminous flux output is desired along the length of the cove illumination module either the spatial density of light-emitting elements which have substantially the same luminous flux output needs to be uniform or alternatively in areas where hot spots occur, the luminous flux output of the light-emitting elements in those areas needs to be controlled in a manner that can appropriately adjust the luminous flux output to achieve the desired uniform illumination. For example, a resistor can be used to alter the current being supplied to a light-emitting element and thus adjust the luminous flux output thereof. Alternately the controller can be a microprocessor which may control the duty cycle of the activation signal provided to the light-emitting elements, thereby controlling the luminous flux output of the light-emitting elements. A worker skilled in the art would readily understand the type of controllers which would be required in order to provide a desired effect.

In one embodiment of the present invention, one or more reflectors can be integrated inside the external housing unit, for example, mounted on the substrate, wherein these reflectors provide a means for redirecting the light produced by the light-emitting elements in a desired direction. These reflectors can be designed in a linear configuration wherein they can be provided along the length of the substrate or optionally a particular reflector can be configured to manipulate the light generated by a particular light-emitting element or group of light-emitting elements. The shapes and design of a reflector can depend on the beam shaping capabilities which are required to generate the desired lighting impression with the one or more light-emitting elements as would be readily understood by a worker skilled in the art. For example the reflectors can be shaped with vertical walls, sloped planar walls, parabolic walls or any other design of reflector as would be readily understood by a worker skilled in the art. In one embodiment, the reflector can be shaped to generate a symmetric beam of light or alternately can be configured to generate an asymmetric beam of light.

In one embodiment of the present invention the one or more reflectors are disposed on or integrated onto the substrate and can collimate the light emitted by the light-emitting elements to provide a first optical element which assists in the creation of the desired lighting impression.

In one embodiment, the electrical interconnection between the modules is provided by a connector that can self environmentally seal when this connector is external to the sealed compartment formed between the external housing unit and the substrate. The connector can have a variety of configurations as would be readily understood by a worker skilled in the art, wherein the configuration can be representative of the information that is being transferred between the cove illumination modules. For example, the connector may be a three-wire connector providing ground, negative and positive poles. Alternatively, if a microprocessor based control circuit is integrated onto the substrate the connector can comprise additional poles in order to provide for parallel data transfer between the cove illumination modules.

Operatively connected to the substrate is an electrical connector for the connection of the substrate to a power supply. The configuration of this connector can be the same or different from the connector for interconnecting two or more cove illumination modules. In one embodiment, all of the connectors are configured for identical mating connections, thereby enabling ease of assembly, manufacture and installation of the cove illumination modules.

In one embodiment, the substrate further comprises a connection system enabling the mating connection between the substrate and the external housing unit. This connection system can be configured as a series of mounting clips that mate with appropriately configured and positioned mating clips which are disposed in the external housing.

### External Housing Unit

The external housing unit can sealingly connect to the substrate wherein the external housing unit can include one or more optical elements which can optically couple to the light-emitting elements on the substrate. The optical elements provide a means for manipulating the illumination generated by the light-emitting elements in a desired manner, for example through the creation of a required beam pattern thereby enabling the illumination of a cove. In one embodiment of the present invention, the one or more optical elements are configured to generate a symmetric beam of light and in an alternate embodiment the one or more optical elements are configure to generate an asymmetric beam of light.

The external housing unit can be manufactured from a variety of materials that can provide a required structural strength. For example the housing can be manufactured from a plastic, metal or other material as would be readily understood by those skilled in the art. If, for example, the housing unit is manufactured from a metal or other potentially conductive material, the design of the external housing unit must account for the positioning of the electrical components on the substrate in order to ensure the desired operation of the cove illumination module. The material can be selected based on the manner in which the external housing unit is manufactured for example.

In one embodiment, the optical elements are integrally formed with the external housing unit which is made of either a diffuse translucent or clear transparent material which enables the manufacture of integrally shaped optical elements. Alternatively, if the optical elements are manufactured separately and subsequently mounted onto the external housing unit, the external housing unit can be opaque or the material of the external housing unit can have any desired optical properties and therefore can be made of metal or other opaque material of adequate strength, for example.

The environmental sealing provided by the external housing unit can be designed to be integrally formed with the external housing unit or can optionally be a separately positioned gasket, O-ring, or sealant which can provide adequate protection for the components on the substrate, for example the light-emitting elements and other electronic components and circuitry. A worker skilled in the art would readily understand alternate sealing techniques that provide the desired level of sealing. In one embodiment the environmental sealing between the substrate and the external housing unit can be non-destructively separated, thereby enabling ease of access to the substrate and the external housing unit if required.

The external housing unit further comprises a plurality of fastening means which provide for the connection between substrate and the external housing unit to be enabled. The fastening means can be configured as mounting clips which can matingly connect with appropriately designed mounting clips on the substrate. Alternately the fastening means can be configured as mounting clips that couple with the bottom of the substrate thereby removing the necessity of mating mounting clips to be provided on the substrate.

In one embodiment, the external housing unit further comprises a secondary fastening means provided for the connection of the cove illumination module to a mounting rail, strut or mounting site, for example. The design of the secondary fastening means can be determined based on the configuration of the mounting rail for example, and the fastening means can also be configured as clips.

In an alternate embodiment, the cove illumination module is directly connected to a surface, wherein the external housing unit provides bores enabling the screwing, bolting or riveting, for example, of the module in the desired location. In another embodiment, the cove illumination module may be mounted using a pressure sensitive adhesive tape or a thermally conductive adhesive for example.

The external housing unit further comprises one or more optics for the manipulation of the illumination generated by the light-emitting elements. In one embodiment, the one or more optics are configured to enable the creation of an asymmetric beam pattern thereby providing a means for the illumination of a cove. In one embodiment, the optics are integrally formed with the external housing unit, or alternately can be manufactured separately for subsequent connection to the external housing unit.

In one embodiment, the external housing unit comprises one optical element for each of the light-emitting elements. In an alternate embodiment, an optical element manipulates the illumination created by two or more light-emitting elements. The optical elements can create any symmetric or asymmetric beam pattern required to generate a desired illumination impression, for example, an illuminated cove such as described in U.S. patent application Ser. No. 11/069,388 which is herein incorporated by reference.

In one embodiment the asymmetric optical system comprises two optical elements that are oriented such that their illumination is directed in different directions, for example, two orthogonal directions. The first optical system, for example a single integrally shaped optical element, can be configured to reduce the beam spread in the first direction, while the second optical system can be configured to increase the beam spread in the second direction.

The function of the first optical system can be to intercept light emitted by the one or more light-emitting elements in a first direction and manipulate this light such that the beam spread is reduced. Light emitted from the light-emitting elements with relatively small beam angles can pass through the first optical system with little or no deviation, whereas light with relatively large beam angles will be refracted such that their beam angles are reduced thus providing an overall reduction in the beam spread of the emitted radiation in the first direction. The first optical system may be larger in cross sectional size when compared to the cross section of the light-emitting element in order to allow manipulation of light with relatively large beam angles.

The first optical system can comprise any optical element, for example, one that can enable the reduction of the beam spread of light as described above such as a lenticular lens or a “pillow” lens or lenses having characteristics of controlling the beam spread of the output light to specific angles and reducing the amount of stray light emitted above the horizontal plane. In addition, as would be readily understood by a worker skilled in the art, reflectors, such as parabolic reflectors, may also be used as the first optical element which may be disposed on the substrate. The first optical element typically has a large cross section in order to be able to collimate or focus beams of light of relatively large beam angle.

The secondary optical system can be oriented in order to intercept light emitted by some of the light-emitting elements of the illumination module in a second direction and has the effect of increasing the beam angle or diffusing the beam of the emitted light. Light beams with relatively small beam angles are intercepted by the secondary optic and diverged resulting in larger beam angles and thus a larger beam spread. Light beams emitted with relatively large beam angles can experience small or no deviations in beam angle, or may not even be intercepted by the secondary optic.

In one embodiment of the present invention, the secondary optical system is disposed such that it can interact with the illumination subsequent to the first optical system on the selected light-emitting elements in a given array of light-emitting elements. This configuration can provide flexibility in modifying the composite beam pattern depending on the position of the light-emitting elements. In addition, this flexibility of allowing the secondary optic to be used with any light-emitting element allows the spacing between light-emitting elements with both the first and second optical elements to be easily varied without necessarily redesigning either of the first or second optical elements.

In one embodiment of the present invention, the first optical element may intercept the light subsequent to its interaction with the second optical element. Therefore, the second optical element would manipulate illumination from selected light-emitting elements prior to manipulation of the illumination by the first optical element.

In one embodiment of the present invention, the first and second optical elements are moulded and cast into a single component. In another embodiment, the second optical element may be a separate component that can be fastened to the first optical element at desired positions, for example.

The second optical system can comprise any element that causes divergence of the light emitted by a light-emitting element as described above. In one embodiment a toroidal shaped lens is used as the second optical element. The diameter of the toroidal shaped lens can be relatively similar in size to the width of the light-emitting element, such that the optic manipulates the portion of the emitted light having a relatively small beam angle and increases this beam angle. Light that is emitted at large angles relative to the optical axis of the light-emitting element may thus not intercept the lens in this second direction and continue to be radiated with essentially its original divergence. A toroidal shaped lens can typically cause a beam angle change from about 0° to about 60°, however this range of beam angle change is dependent on the design of the second optical element and thus may be smaller or larger, as would be readily understood by those skilled in the art.

In one embodiment of the present invention, the second optical system can comprise a configuration of two Fresnel lenses in which one Fresnel lens is designed to refract light to a different extent than the second Fresnel lens. In this embodiment, a collimating optical element can be mounted on the substrate which can be used as part of the first optical system. After interaction with the first optical system the illumination subsequently interacts with the Fresnel lenses thereby adjusting the direction of the illumination. It would be understood that any collimating element can be used as part of the first optical system as described earlier. The Fresnel lenses are configured to redirect light to different emission angles depending on distance to the illuminated surface. For example the Fresnel lens closest to the illuminated surface can throw light further down the surface and the further Fresnel lens can throw the light higher up the wall surface. As would be readily understood the Fresnel lenses can be configured to operate in the reverse manner. The lighting result can be a more uniformly and effectively illuminated surface.

This embodiment can allow for the production of “graze” lighting of a surface, such as a wall, that is parallel to the centre axis of the emitting direction of the light-emitting elements. Each Fresnel lens comprises a plurality of Fresnel prisms and the Fresnel prisms furthest away from the target surface refract the light from the light-emitting elements such that it illuminates the portion of the wall that is closest thereto. The Fresnel prisms closest to the target surface refracts the emitted light such that it refracts the light to create the “grazing” feature and can illuminate the portion of the wall that is furthest away from the light-emitting elements. It would be obvious to one skilled in the art that the second optical element can comprise two or more Fresnel lenses each refracting light from the light-emitting elements at a desired degree in order to illuminate a surface of a particular shape or orientation.

Other configurations of the optical elements for the creation of a desired symmetric or asymmetric beam pattern are possible and would be readily understood by a worker skilled in the art given the above description and embodiments.

The invention will now be described with reference to specific examples. It will be understood that the following examples are intended to describe embodiments of the invention and are not intended to limit the invention in any way.

### EXAMPLES

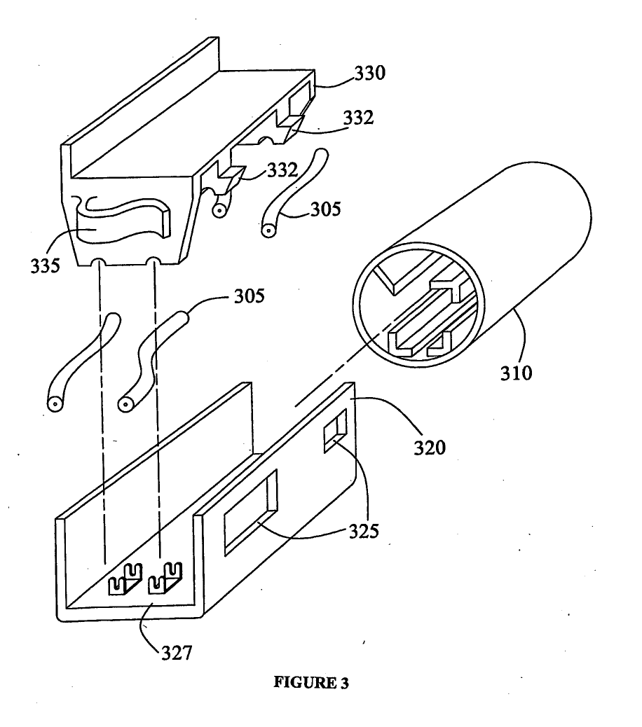

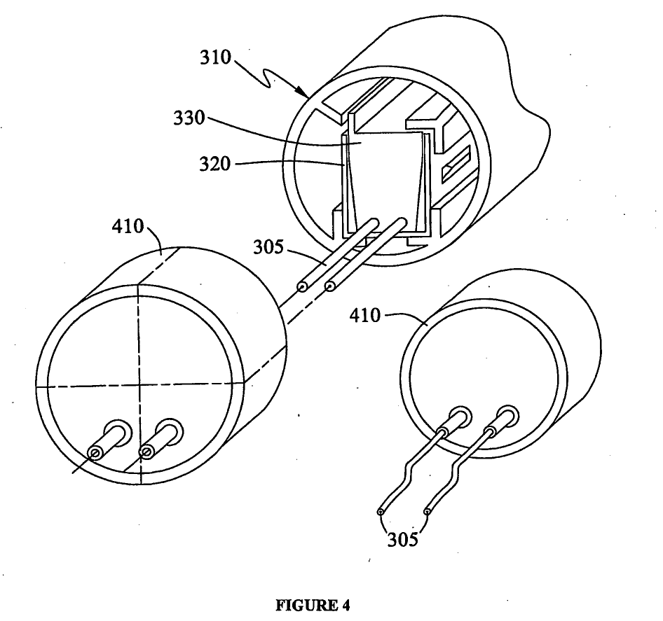

Reference is now made to FIG. 3 and FIG. 4, which illustrate a cove illumination module that comprises a tubular external housing 310 according to one embodiment of the present invention. FIG. 3 illustrates an exploded view and FIG. 4 illustrates an assembled view of the cove illumination module. The housing 310 can have any desired cross section and it can also be flexible or pliable. The illumination module also comprises light-emitting elements (not shown in FIGS. 3 and 4) which are mounted to an elongated narrow MCPCB substrate (not shown). The substrate also bears electronic drive current circuitry for the light-emitting elements that requires, for example a 24V DC power supply to power a series of interconnectible cove illumination modules. Electrical control or power connections of the substrate can be achieved via wires 305 which can be connected to insulation displacement connectors 327. An optical element 330 is positioned typically above the light-emitting elements so as to enhance the optical characteristics of the light emitted by the light-emitting elements. The optical element 330 includes tabs 332 that cooperate with mounting details 325 of the heat sink 320. The optical element 330 can be interchangeable to provide a variety of light characteristics and beam shaping requirements that can generate a desired illumination impression.

The substrate can be disposed and thermally connected to a heat sink 320 which comprises an elongated U-shaped profile made of thermally conductive material, for example aluminium. In one embodiment, the heat sink 320 and the substrate can be shaped to form a unitary body. Alternatively, the heat sink 320 and the substrate can be two separate components (not shown). The heat sink 320 can be positioned by sliding it inside the housing 310. The housing 310 can provide suitably shaped protruding guide elements (not shown) on its inner walls for alignment of the heat sink 320 within the housing 310 during and after insertion. The housing 310 can additionally provide axial indexing elements on an inner wall along the length thereof for alignment of an inserted heat sink 320 along the length of the housing 310 or to move it relative to the housing 310 at spaced intervals. The heat sink 320 can have optional alignment elements (not shown) that can mate with the indexing elements of the housing 310.

As shown in FIG. 3, the optical element 330 can advantageously terminate in a connector element 335 at either end that can be used to attach two equally aligned heat sinks 320. For example, the optical element 330 can have connector element 335 and an antisymmetrically aligned connector element 335 (not shown) on the opposite end of the optical element 330 such that a pair of antisymmetrically aligned connector elements 335 of adjacent optical elements 330 can matingly fit into each other to provide a detachable connection.

The heat sink 320 can be a sheet metal and can be extruded or machined and it can be manufactured to predefined lengths such that one or more interconnected substrates can be disposed to the heat sink 320 or one or more heat sinks 320 can be disposed inside the housing 310. Relative alignment of the substrate and the heat sink 320 can be accomplished through optional half shear bumps (not shown) disposed along the inside of the heat sink 320 so that any shear bump can stop a sliding substrate from further movement when an edge of a substrate abuts that shear bump without exceeding a threshold shearing force. Consequently any substrate that fits inside the braces of the U-shaped heat sink 320 can be durably positioned between pairs of consecutive shear bumps.

If required, the substrate can be fastened to the heat sink 320 for example with screws. In one embodiment, a self adhesive thermal transfer material is used which can provide a bond between the substrate and the heat sink 320 as well as provide a thermal connection there between. The heat sink 320 further comprises mounting details 325 to attach an optical element 330 to be held in place and in optical alignment with the light-emitting elements on the substrate when positioned inside the housing 310.

The housing 310 can have any desired cross section and it can be sealed at each end with a suitable end cap 410 provided at the respective ends of the housing 310 as illustrated in FIG. 4. The end caps 410 include apertures for a feed through locations for the electrical connections. The end caps 410 can be hermetically sealed to the ends of the housing 310 so as to prevent moisture or dirt from penetrating inside the housing 310. The feed through locations in the end caps can be provided in several ways, for example, wires can pass through holes in the end cap 410 which are bonded and sealed in place with adhesive, or wires can pass through protruding tubes which are moulded in the end cap 410 and can provide a hot melt adhesive-lined heat shrink tube bonds to seal the space between the wire 305 and the end cap 410. In another embodiment, the end cap 410 can provide an over moulded connector into which a power cable connector can be plugged, or the end cap 410 can be a moulded, adhesive filled, with heat-shrink tubes that shrinks and bonds both to the end of the housing 310 and the electrical connections. The various sealing methods can additionally provide a strain-relief location for the electrical connections, thereby providing an desired amount of relative movement between the electrical connections and the housing for example.

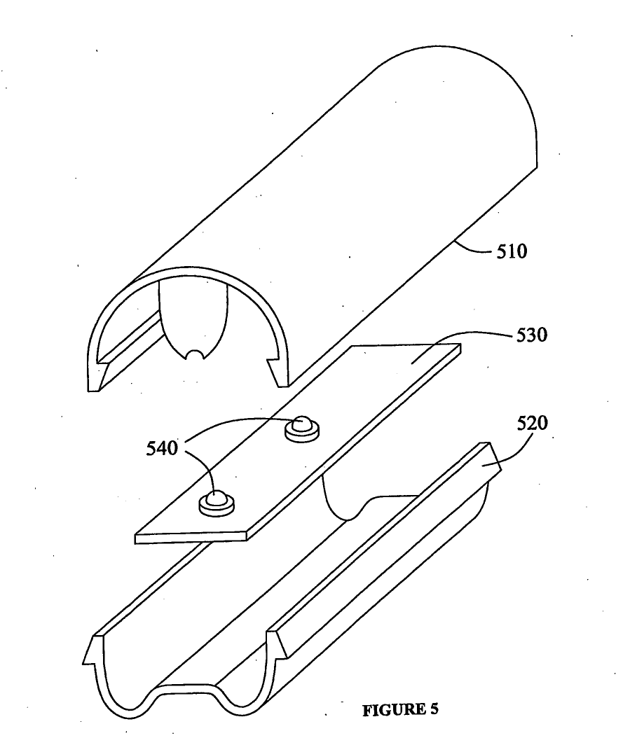

FIG. 5 illustrates a cove illumination module according to another embodiment of the present invention. The cove illumination module comprises a diffuser structure 510 which can be made of polycarbonate plastic, for example LEXAN™, or other suitable material as would be known to a worker skilled in the art, such that it forms a half tube with a U-shaped cross section that has two layers of diffusion, separated by a space that covers all light-emitting elements 540. Optical lenses can optionally be positioned relative to and attached to the light-emitting elements 540. The combination of heat sink 520, substrate 530 with light-emitting elements 540 and additional optical elements (not shown) can be inserted into or attached to the housing as a single unit.

In an alternative embodiment, the diffuser 510 and the substrate 530 constitute the housing for the illumination module. It is understood, that the heat sink 520 and the substrate 530 can be formed into a single body, which can have a U-shaped cross section, which can improve heat transfer by providing an intimate thermal connection between the heat sink 520 and the substrate 530.

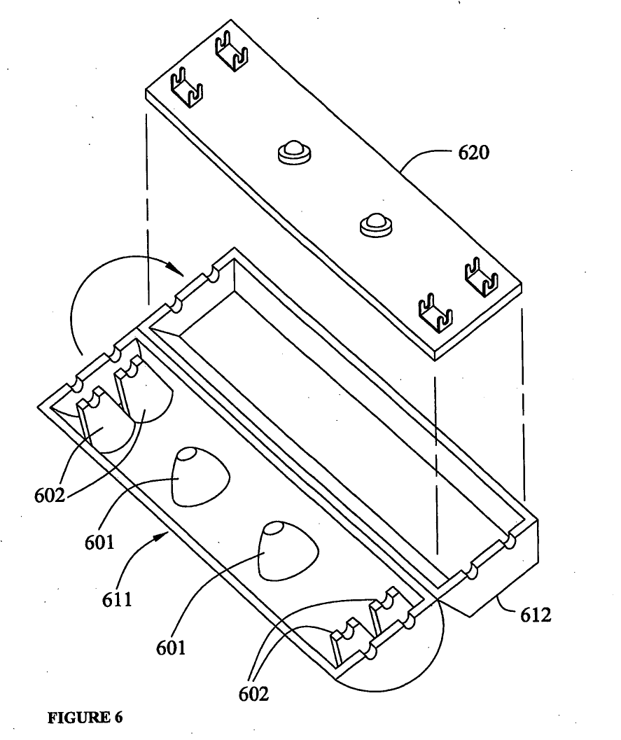

FIG. 6 illustrates a cove illumination module according to another embodiment of the present invention. The cove illumination module comprises a housing that comprises two hinged halves 611 and 612 which can be pivotally connected along a transverse side edge or, as illustrated a longitudinal side edge and can be closed by folding and detachably securing the two halves with mating means such as snap fit connection or the like. Alternatively, the housing can comprise two separate halves which can have a number of mating details to detachably secure the two halves together. A substrate 620 can be disposed inside the housing, wherein the housing can optionally include support beams 601 and strain relief beams 602 which can provide additional structural rigidity to the housing.

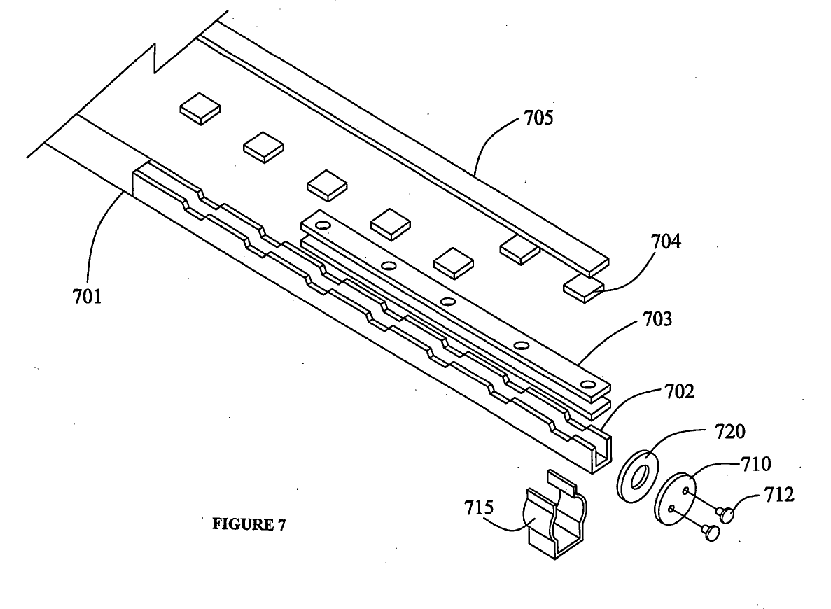

FIG. 7 illustrates a cove illumination module according to another embodiment of the present invention. The cove illumination module comprises a housing 701, heat sink 702, substrate with light-emitting elements 703, optical elements 704, and secondary optical elements 705. The cove illumination module further comprises an end cap configuration which comprises a gasket 720, an end cap 710, end cap fasteners 712, and an end cap mounting bracket 715. Mounting brackets 715 for the cove illumination module can be configured in several formats as would be known to a worker skilled in the art. In one embodiment the mounting brackets are formed as resilient deformable “snap clips” which can secure to the outside of the housing thereby providing a means for securing the position of the cove illumination module.

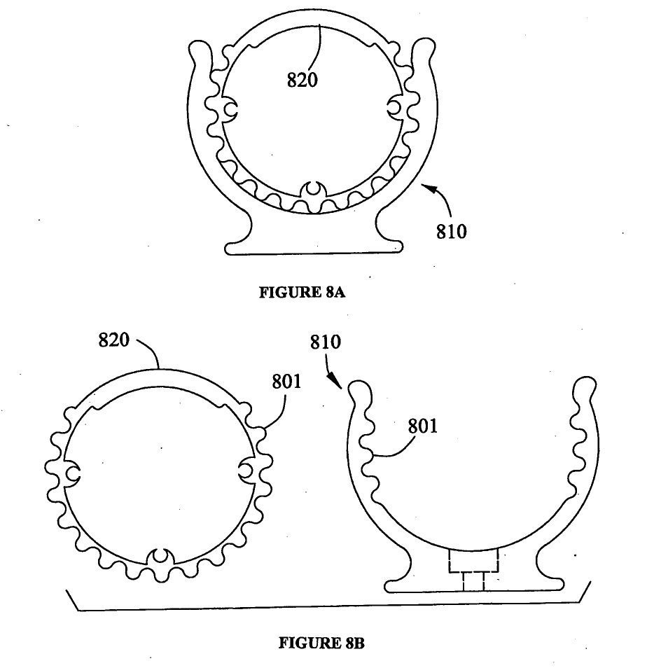

Reference is now made to FIG. 8A which illustrates a snap clip 810 mated with a housing 820 for securing a cove illumination module in position. FIG. 8B illustrates the snap clip 810 and the housing 820 separated. The tubular shaped housing 820 can be snapped in and a friction fit can allow indexed or arbitrary rotational adjustability by using either ribbed interface surfaces 801 or smooth interface surfaces (not shown) between housing and clip for aiming the light at a to-be-illuminated surface or target.

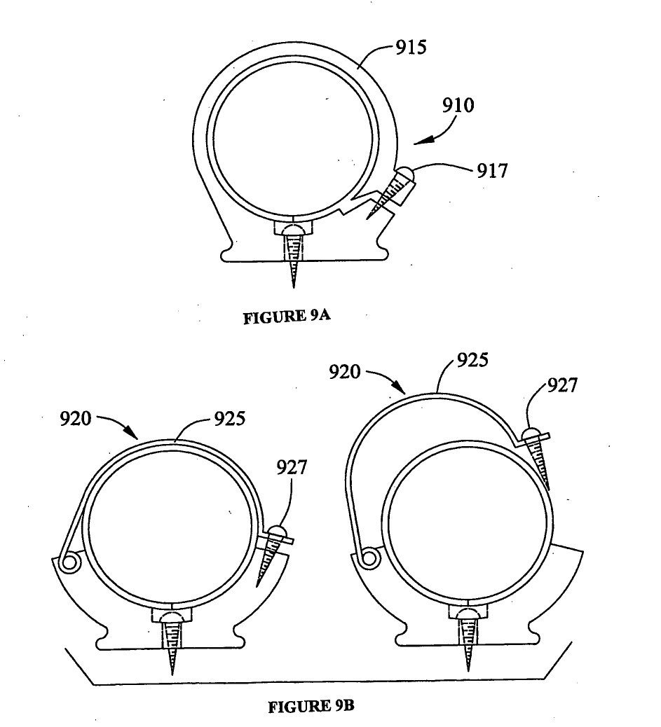

FIG. 9A illustrates a first type of lock bracket 910 and FIG. 9B illustrates second type of lock bracket 920. Spring clips 915 and 925 provide a means for rotational positioning of the housing of a cove illumination module which can be secured with a snap (not shown) or a screw 917 or 927. The spring clip 915 or 925 can be, for example, a pivotally hinged spring clip 925 or rotation lock bracket 915 for adjustably positioning of the housing thereby aiming the light emitted by the cove illumination module. Depending on the frictional connection between the lock bracket 910 and 920, and the housing of the housing of the cove illumination module, which can be adjusted using the spring clips 915 and 925, respectively, the longitudinal movement of the cove illumination module housing relative to the mounting surface, due to differential thermal expansion between the cove illumination module relative to the mounting surface can be provided. This can be achieved by having one “fixed” lock bracket locked to the cove illumination module housing, thus defining the point from which the module will expand and contract, and additional lock brackets may be provide for positioning of the cove illumination module but allow for axial expansion and contraction of the cove illumination module.

In one embodiment, relatively short cove illumination modules may only require one fixed lock bracket but longer modules may require one fixed bracket and one or more secondary lock brackets that can transversely position a portion of the housing but allow the module to slide axially within these non-fixed lock brackets. The fixed lock bracket can also be made to provide a factory set rotational index at specific one or more predefined aiming angles to eliminate installation errors, for example the housing of the cove illumination module and the lock bracket can each comprise mating indexing features, thereby enabling predetermined rotational positioning.

In one embodiment of the present invention, the cove illumination module provides light-emitting elements mounted on a substrate with an integrated thermal management system and an optical system fully contained within an environmentally sealed housing. As is known, a heat sink is typically in contact with the ambient environment rather than sealed within a non-vented housing. A cove illumination module according to the present invention, was subject to thermal testing experiments which demonstrated that densely positioned high power light-emitting elements of, for example about one Watt or more can be permanently operated at junction temperatures of about 72° C. at about 23° C. ambient temperature. These results show that that cove illumination module can be operated at ambient temperatures of up to about 60° C. without damaging the light-emitting elements.

In one embodiment of the present invention, during assembly of the cove illumination module, the housing can be pressurized prior to insertion of the heat sink assembly. This pressurization of the housing can spread the sides of the housing thereby enabling a slightly larger dimensional heat sink assembly to be inserted. Upon removal of the pressure the cross section of the housing can return to about its original size, thereby forming intimate thermal contact between the sides of the heat sink and the heat sink assembly.

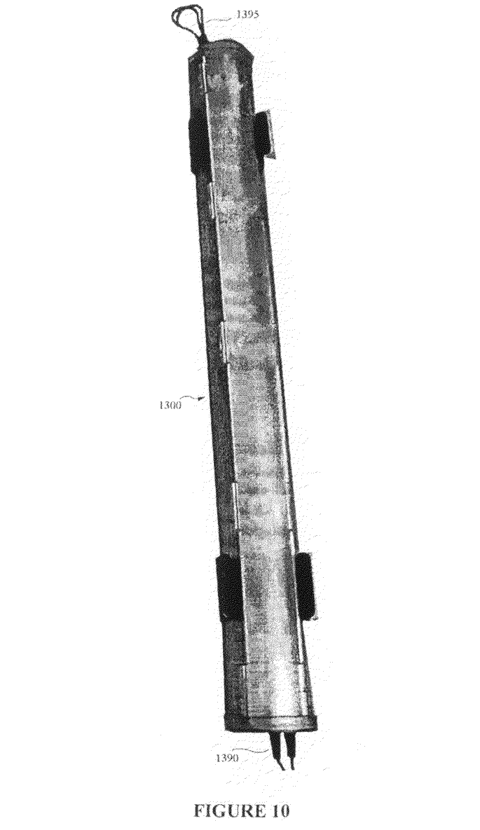

FIG. 10 shows an illustration of an assembled cove illumination module 1300 according to one embodiment of the present invention. Also illustrated is additional wiring 1390 and 1395.

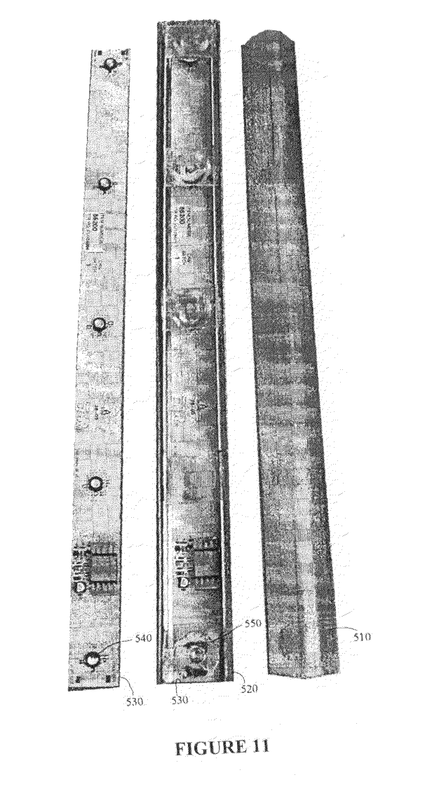

FIG. 11 shows an illustration of the components of the cove illumination module of FIG. 10. The substrate 530 includes light-emitting elements 540 at spaced intervals. The substrate 530 is inserted in the heat sink 520 which can be enveloped by diffuser housing 510.

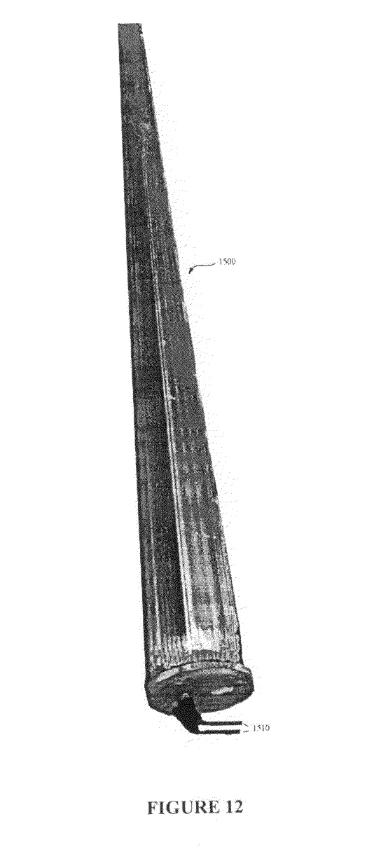

FIG. 12 shows an illustration of an assembled cove illumination module 1500 according to another embodiment of the present invention. Also illustrated are two wires 1510 for connection to a power supply.

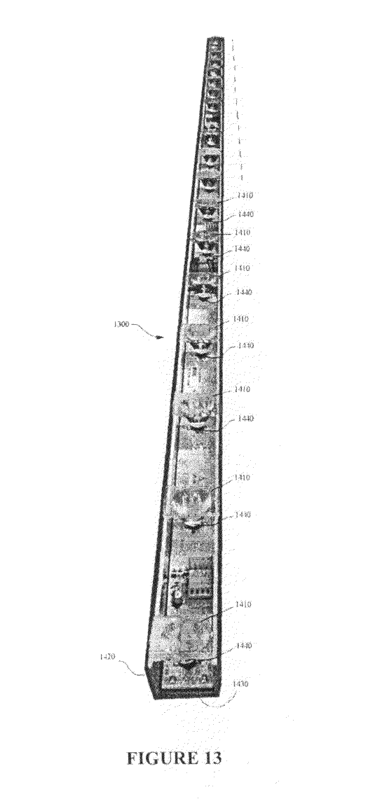

FIG. 13 shows an illustration of an insert comprising the light-emitting elements 1440 and optical elements 1410 for use with the cove illumination module of FIG. 12. The insert 1300 comprises a plurality of light-emitting elements 1440 operatively disposed on a substrate 1430 which is inserted in a heat sink 1420. The light-emitting elements 1440 can be optically coupled with optical elements 1410.

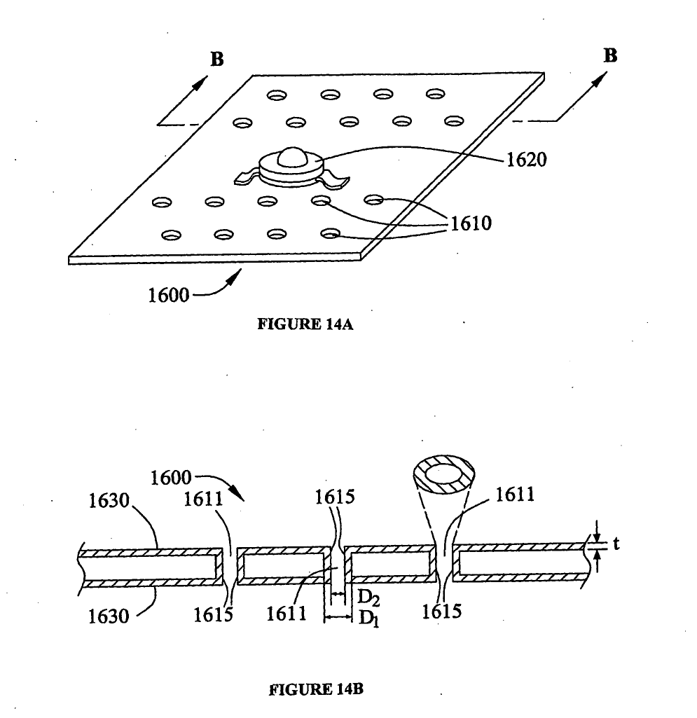

FIGS. 14A and 14B illustrate a perspective view and a cross sectional view, respectively, of a substrate 1600 with vias 1610 and a light-emitting element 1620. The vias 1610 comprise bores 1611 in the substrate 1600 which are coated with thermally conductive material 1615, for example diamond or metals such as silver, aluminium or copper. Vias 1610 can facilitate heat transport through the substrate 1600 and vias 1610 can also impede lateral heat transfer across epilayers 1630 of thermally conducting material on the surface of the substrate. The distribution of vias on the substrate around a heat source, for example, an operative light-emitting element 1620 can affect the heat dissipation from that source of heat. Consequently, the vias can be disposed in order to improve the heat dissipation, and, for example, to reduce the operating temperature of the light-emitting element 1620 under operating conditions. In addition, the number of vias required can be reduced in order to improve the cost-effectiveness of manufacturing the substrate. Provided that the vias 1610 are about equal in size, and the vias 1610 and the epilayer 1630 comprise material of substantially the same thermal characteristics, for example, the same material, it can be shown that an ideal number N of vias can be derived by the following:

$$N = \frac{t \cdot L}{t \cdot {D}_{2} + \frac{π}{4} ( {D}_{1}^{2} - {D}_{2}^{2} )} \qquad ( 1 )$$

wherein t is the thickness of the epilayer, L is the total width of the epilayer, D₁ is the outer diameter of a via, and D₂ is the inner diameter of a via.

The substrate 1600 can provide a number of vias 1610 at a certain distance as described by the foregoing formula, for example, disposed in a single row or concentrically around a source of heat. In order to achieve a substantially an ideal thermal dissipation with a minimal number of vias 1610 about half the number of vias 1610 are required at a next greater distance.

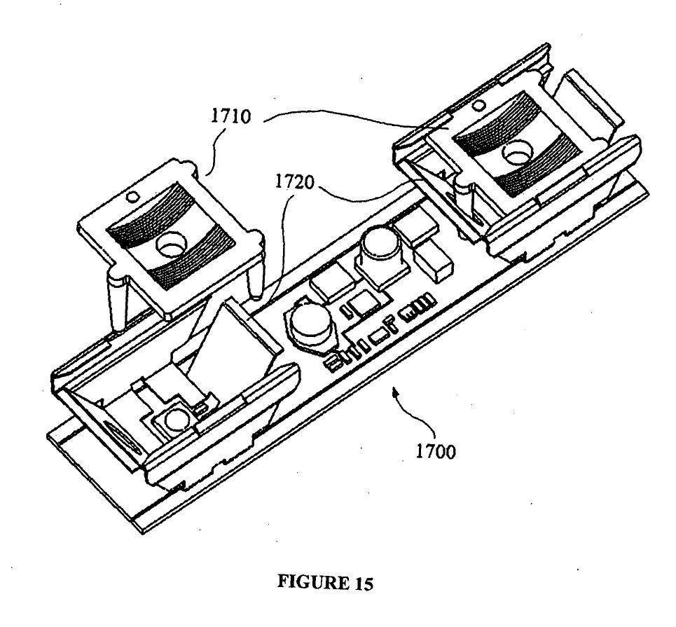

FIG. 15 illustrates a substrate 1700 with light-emitting elements and optical elements mounted thereon which can be inserted into the housing of a cove illumination module according to one embodiment of the present invention. A reflector 1710 and a metallic clip 1720 per light-emitting element or group of light-emitting elements is mounted onto the substrate. Each metallic clip provides for easy centric positioning of a reflector which can provide for effective optical functionality of the cove illumination module. A reflector can be attached to a metallic clip which provides for easy and cost effective assembly. The clip can optionally provide a non-destructive releasable connection. Each clip 1720 provides additional cooling to the light-emitting element or the light-emitting elements.

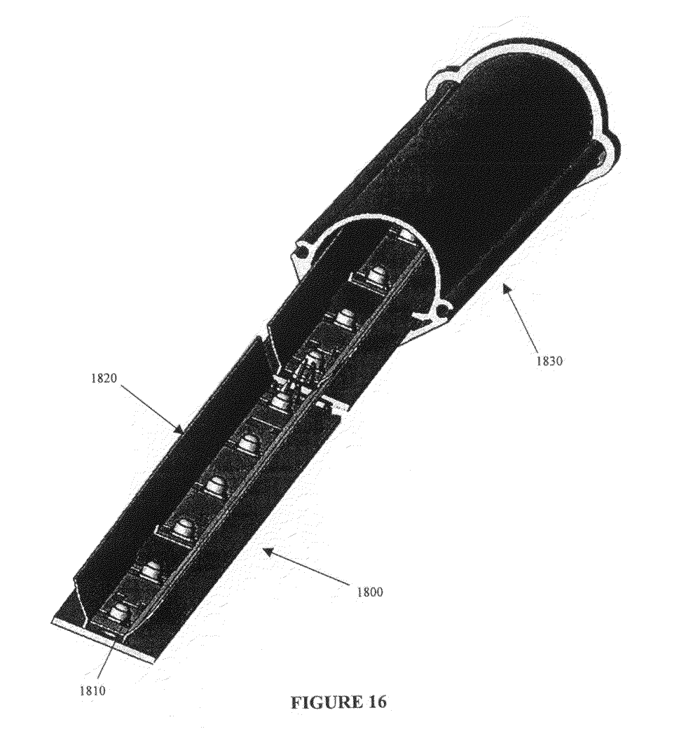

FIG. 16 illustrates a cove illumination module according to one embodiment of the present invention wherein the substrate which components mounted thereon is being inserted into the housing 1830. The substrate 1800 has mounted thereon a plurality of light-emitting elements 1810 and an elongated reflector element 1820 which provides a means for manipulating the light generated by the light-emitting elements.

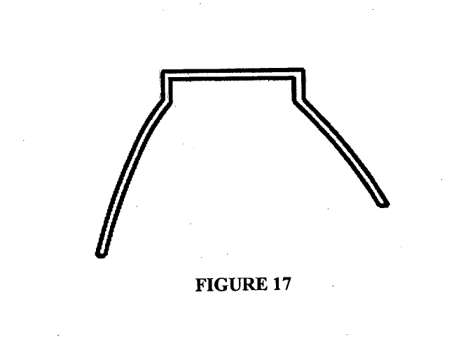

FIG. 17 illustrates a cross section of the elongated reflector element of a cove illumination module illustrated in FIG. 16. The elongated reflector element has an asymmetric cross section to facilitate the generation of asymmetric illumination patterns. While, the elongated optical element can be used in the cove illumination module illustrated in FIG. 16, it can also be used in alternate cove illumination module configurations. The elongated optical element, like other elongated profiles, substantially only requires transverse alignment relative to the axis of the light-emitting elements in the cove illumination module. This elongated reflector element can be substantially indifferent to longitudinal shifts along the longitudinal axis of the cove illumination module. This design of the elongated reflector element can facilitate the assembly process of the cove illumination module.

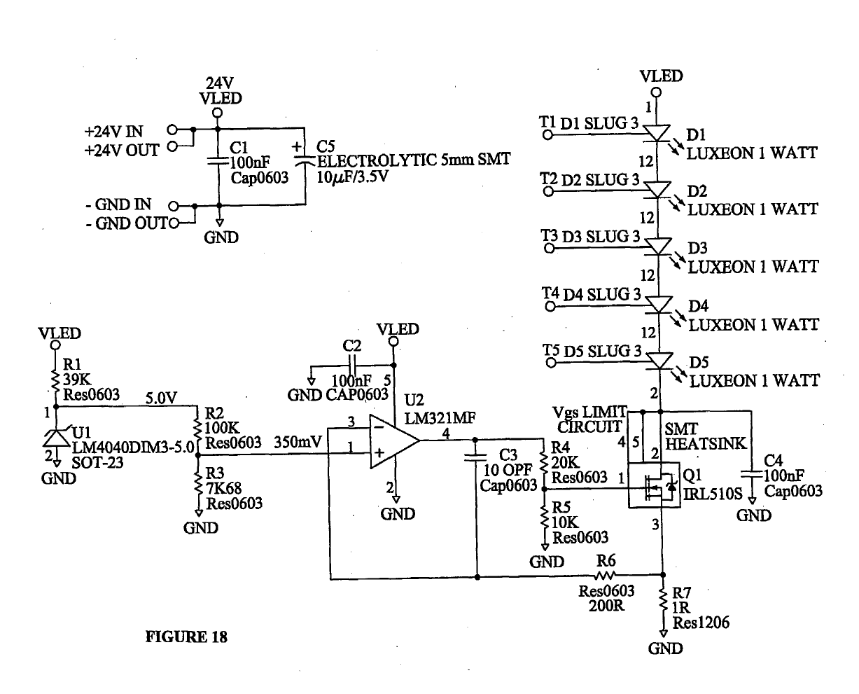

FIG. 18 illustrates a schematic of a light-emitting element drive current control circuitry for light-emitting element drive current control according to one embodiment of the present invention. The circuit comprises a series connection of five light-emitting elements which are connected in series to a transistor based controllable switch IRL510S and resistor R7. Operational amplifier (OPAMP) LM321MF via its negative terminal samples the voltage drop across resistor R7 which provides a measure for the light-emitting element drive current. The OPAMP provides a control voltage to the switch to adjust the voltage drop across R7 to be equal to the input voltage provided at the OPAMPS positive input control terminal. Consequently, the control circuit maintains the light-emitting element drive current to closely proportionally follow the input voltage at the OPAMP input control terminal. The rest of the control circuitry comprises voltage resistor based dividers and capacitor based voltage stabilizers as are well known to someone skilled in this art. As it can be appreciated by those skilled in the art, the circuit can be configured and adapted to effectively drive other numbers of light-emitting elements.

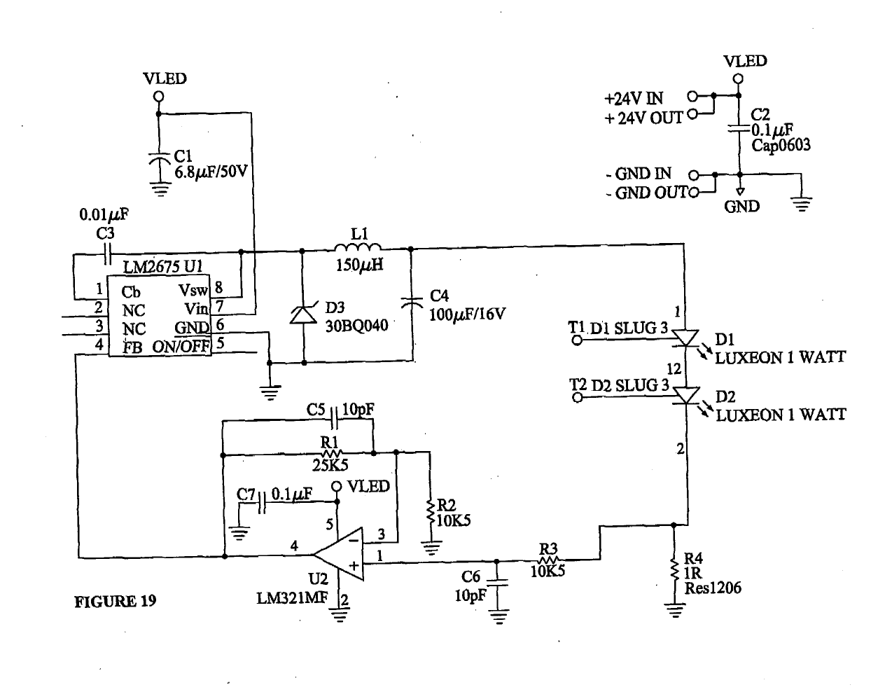

FIG. 19 illustrates a schematic of a feedback light-emitting element drive current control circuitry for light-emitting element drive current control according to one embodiment of the present invention. The circuit comprises a series connection of a Schottky diode, inductance, and capacitor based drive current stabilization circuit, two light-emitting elements D1 and D2, and a drive current shunt resistor R4. The series connection is connected to a switching power converter, as illustrated for example LM2675, which provides a controllable drive current. An operational amplifier, as illustrated for example LM321MF, is connected to the power converter to provide a filter based feed back control voltage conversion providing a measure of the drive current to the power converter. The system is connected to a suitable power supply at VLED. The rest of the control circuitry comprises capacitor based voltage stabilizers as are well known to those skilled in this art.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A cove illumination module for illuminating a cove, the module comprising:
a) a substrate having one or more light-emitting elements operatively mounted thereon, said one or more light-emitting elements generating light having one or more wavelengths; and
b) an external housing unit sealingly connected to the substrate, said external housing element including one or more optical elements optically coupled to the one or more light-emitting elements, said one or more optical elements manipulating the light in a desired manner thereby illuminating the cove;
wherein the substrate is adapted for connection to a source of power thereby enabling activation of the one or more light-emitting elements.

2. The cove illumination module according to claim 1 further comprising a heat sink thermally connected to the substrate.

3. The cove illumination module according to claim 1, wherein the substrate is configured as a metal core printed circuit board or a FR4 board.

4. The cove illumination module according to claim 1, further comprising a reflector mounted on the substrate, the reflector optically coupled to one or more of the light emitting elements.

5. The cove illumination module according to claim 4, wherein the reflector is configured as a linear reflector having a uniform longitudinal cross-sectional shape.

6. The cove illumination module according to claim 5, wherein the longitudinal cross sectional shape has one or more walls, the one or more walls being vertical, parabolic or sloped.

7. The cove illumination module according to claim 4, wherein the reflector is configured to generate an asymmetric beam of light or symmetric beam of light from the light generated by the light-emitting elements.

8. The cove illumination module according to claim 1, wherein the external housing unit is manufactured from a metal.

9. The cove illumination module according to claim 1, wherein the external housing unit and the one or more optical elements are integrally formed.

10. The cove illumination module according to claim 1, wherein the one or more optical elements are configured to generate an asymmetric beam of light or a symmetric beam of light from the light generated by the light-emitting elements.

11. The cove illumination module according to claim 1, wherein the one or more of the optical elements are configured as a lens.

12. The cove illumination module according to claim 10, wherein the lens is a lenticular lens, toroidal shaped lens, Fresnel lens or pillow lens.

13. A cove illumination system comprising two or more cove illumination modules according to claim 1, said two or more cove illumination modules operatively coupled for operation thereof.

14. The cove illumination system according to claim 13, wherein the two or more cove illumination modules are operatively connected by an environmentally sealable electrical connection.
